(19) United States
(12) Patent Application Publication
(10) Pub. No.: US 2010/0270943 A1
(43) Pub. Date: Oct. 28, 2010

(54) COLLEGE AND PRO SPORTS FRAGRANCE OIL WARMERS

(76) Inventor: LEA COOK, Bossier, LA (US)

Correspondence Address: Thien Tran/ Access Patent Group, LLC, 7706 Tanner Robert Court, Springfield, VA, 22153, US

(21) Appl. No.: 12/766,831

(22) Filed: Apr. 23, 2010

Related U.S. Application Data
(60) Provisional application No. 61/171,869, filed on Apr. 23, 2009.

(51) Int. Cl. H05B 41/36; F21V 33/00; F21L 4/00

(52) U.S. Cl. 315/291; 362/253; 362/183

(57) ABSTRACT

A college and pro sports fragrance oil warmer device which includes a housing having a number of sides, a bottom wall and an open top. A fragrance producing medium is disposed in a glass bowl upon the top wall of the housing. A light mechanism within the housing is for heating the fragrance producing medium to pleasantly scent vapor in a room. A sports name and logo are simultaneously displayed on at least one side of the housing. The oil warmer device produces light, fragrance, sports'team message and sports'team logo simultaneously.

### CROSS-REFERENCE TO RELATED APPLICATION

This application claims the benefit of Provisional Patent Application No. 61/171,869, filed on Apr. 23, 2009, In the United States Patent & Trademark Office, the disclosure of which is incorporated herein by reference.

### BACKGROUND OF THE INVENTION

1. Field of the Invention

The present invention relates to an air freshener, and more particularly, a college and pro sports warmer device.

The college and pro sports warmer device provides sports enthusiasts with a simple way to show their team pride while pleasantly scenting the air in a room. The device can assist anyone in showing their spirit and loyalty for their favorite college or professional sports team while also allowing a pleasurable fragrance to permeate the air. The device is ideal for use in residential and commercial establishments to show a team affiliation while also providing an additional function.

2. Description of the Prior Art

Before a football game, people like to dress up in their team's colors or otherwise don the team's name. Some may buy banners, dishes, pillows and other items in order to show their team pride within the decor of a particular room. Many decorative items serve no other purpose other than showing loyalty to a specific college or professional team. While company may be visiting to watch a favorite team play, homeowners may wish for a simple way to provide a pleasant smell to a room. Having an electric oil warmer specially designed to showcase the mascot, name and other relative attributions to a specific team may assist individuals in celebrating their favorite athletic teams surrounded by pleasant-smelling air.

Numerous innovations for decorative lighting systems have been provided in the prior art that will be described. Even though these innovations may be suitable for the specific individual purposes to which they address, however, they differ from the present invention.

A FIRST EXAMPLE, U.S. Pat. No. 5,807,093, Issued on Sep. 15, 1998, to Tendrick Sr. teaches an outdoor torch that has a housing including a receptacle for removably receiving a flaming illumination means, such as an oil burner assembly, a support connected to the lower end of the housing for support the housing in an upright position and a flame guard of a fire resistant material, preferably in the form of a generally cylindrical sleeve and having opposed open ends, surrounding the outer surface of the housing for preventing flame from the oil burner assembly from contacting the housing.

A SECOND EXAMPLE, U.S. Pat. No. 5,876,678, Issued on Mar. 2, 1999, to Harrell et al. teaches an air freshener which has a rigid plastic frame, a hollow shell of translucent, open cell foam which is placed over the frame and which is impregnated with a scent agent, a base which is removably connected to the frame and which has a light bulb extending therefrom into the interior of the frame for illuminating the shell and for heating the scent agent to increase its dispersion.

The frame and shell are manufactured in the shape of a basketball, baseball, or other piece of sports equipment and the shell is imprinted with a name or team logo.

A THIRD EXAMPLE, U.S. Patent Office Publication No. 2006/0002102, Published on Jan. 5, 2006, to Leonard teaches a volatile material dispensing system with a dispenser for providing controlled release of a volatile material, the dispenser being attached to a display frame, the display frame is secured to a base member that additionally retains an illuminating means. The illuminating means provides a pleasing ambiance in conjunction with the pleasant air freshener released by the dispenser.

A FOURTH EXAMPLE, U.S. Patent Office Publication No. 2006/0227541, Published on Oct. 12, 2006, to Reichlin Jr. et al. teaches a floating candle holder. The floating candle holder comprises a dish or base and a three dimensional candle support for facilitating birthday well-wishes. For instance, the floating candle holder is ideal for placing a lighted birthday candle into an alcoholic or non-alcoholic beverage as a means for presenting an individual a birthday salute. The three-dimensional candle support can take an infinite number of shapes and appearances. For example, if the recipient is a sports fan, the three-dimensional candle support may take the form of a football, basketball or baseball. The three-dimensional candle support is also ideal for carrying advertisements, logos and/or messages. Continuing with the previous example, a football-shaped three-dimensional candle support may carry the message “HAPPY BIRTHDAY.”

A FIFTH EXAMPLE, U.S. Patent Office Publication No. 2007/0177394, Published on Aug. 13, 2007, to Vock et al. teaches a flickering display system that has: a display, a microprocessor, one or more light emitting diodes and digital memory, the memory storing one or more digital images of a lighted candle. Under control of the microprocessor, the digital images are displayed on the display and the diodes activate in a flame area of the candle such that, when viewed, the digital images and diodes appear like a real candle. Optionally the system includes an aroma generator that produces a scent similar to the scent produced when burning a scented candle.

A SIXTH EXAMPLE, U.S. Pat. No. 7,410,269, Issued on Aug. 12, 2008, to Harrity et al. teaches a decorative light system which includes a base and a portable light device capable of communicating with each other to generate a light show. The system includes a base defining a receptacle and including a microcontroller, a transceiver operably coupled to the microcontroller and adapted to generate a control signal, a first power source operably coupled to the microcontroller, and a user interface operably coupled to the microcontroller and including at least one switch for activating the microcontroller. The portable light device has a lower end sized for removable insertion into the base receptacle and includes a housing having at least a portion formed of a translucent material, a first receiver disposed within the housing and responsive to the control signal transmitted by the base transceiver, a first light source disposed within the housing, operably coupled to the receiver, and adapted to direct light toward the translucent portion of the housing, and a second power source disposed within the housing and operably coupled to the light source.

A SEVENTH EXAMPLE, U.S. Patent Office Publication No. 2008/0260595, Published on Oct. 23, 2008, to Slater teaches a sports team display system combined with vehicle air freshener that aids in a vehicle driver's ability to prominently display his or her support for an athletic team or organization while at the same time provides a pleasant smell to emit throughout the interior of the vehicle. The system is designed so that it will remain in a stationary position while continuing to prominently display itself while emitting the pleasant smell.

AN EIGHTH EXAMPLE, U.S. Patent Office Publication No. 2009/0073694, Published on Mar. 19, 2009, to Scannell Jr. teaches a decorative container which includes: (a) a base; (b) a top component being removably attached to the base; (c) at least one access opening having a location being selected from the top, side, and bottom of the decorative container where the opening may be in at least one of the base and top component; (d) at least one electrical system component housing and at least one electrical system component requiring an electric power receptacle; and, (e) the decorative container is one of a plurality of decorative containers, each having local area network system communications capability for local area network system connection to at least one other decorative container. A pedestal is adapted to receive a nesting item atop it and adapted to perform at least one additional function in addition to pedestal. The pedestal includes: (a) a pedestal component having an enclosed structure with a bottom adapted to rest upon a horizontal surface, and having an electrical system component support within the enclosed structure, the pedestal component having a top with one of a male and a female nesting member adapted to receive the other of a male and female nesting member attached to a separate nesting item; (b) at least one electrical system component requiring an electric power receptacle; and, (c) the pedestal is one of a plurality of pedestals, each having local area network system communications capability for connection to at least one other the pedestal.

A NINTH EXAMPLE, U. S. Pat. No. 7,611,253, Issued on Nov. 3, 2009, to Chein teaches a multiple function LED night light with air-freshener that includes an LED display unit with light-medium properties to allow light beams from LED(s) located at LED input-ends of the display unit to travel within the light-medium and be uniformly emitted through a surface of the display for even brightness without hot spots. A housing of the night light includes a slot, space, room to allow an air-freshener, an LED display, a sealed-unit and all related electric components including a heat element or fan device to be disposed within the night light housing to provide multiple functions in addition to those of a conventional night light.

A TENTH EXAMPLE, U.S. Pat. No. 7,658,507, Issued on Feb. 9, 2010, to Thomas teaches an image projecting candle apparatus which is constructed of a generally elongated cylindrical body with a candle positioned therein and an annular display unit mounted on a top rim of the cylindrical body with colored transparent film mounted in the display unit and for turning by heated air rising out of the cylindrical body such that a team color of a person's favorite sports team can be projected either on the ceiling or on a wall.

ELEVENTH EXAMPLE, U.S. Patent Office Document No. 2005/0142508, issued on Jun. 30, 2005, to Lee et al. teaches an automatic power-off control circuit of essential oil burner is provided for controlling the heating of the essential oil in the essential oil burner, and cutting off power when the essential oil in the essential oil burner is used up. The control circuit includes a power-on switch, an AC/DC transformer, a signal detection circuit, a signal amplifier, and a heating device. The power-on switch is connected in series between an AC power supply and the AC/DC transformer. The power-on switch is connected in parallel with a power self-holding circuit so that the AC power supply keeps supplying power to the heating device to heat the essential oil in the bowl when the switch is pressed and the signal detection circuit detects the presence of essential oil in the bowl of the essential oil burner. When the signal detection circuit detects that essential oil is used up in the bowl, the self-holding circuit relieves its self-holding state and cuts off the supplying of the power to the heating device. The control circuit further includes a heating indicator and a night light circuit.

TWEVELTH EXAMPLE, U.S. Patent Office Document No. 2005/0045622, issued on Mar. 3, 2005, to Huang, teaches an improved structure of a fragrant essence burner is composed of furnace body and electric heat device; particularly, resistance detection element is set in the bottom wall of the container of furnace body for detecting the presence of water in the container to control power source of the electric heat element.

THIRTEENTH EXAMPLE, WIPO PATENT OFFICE DOCUMENT NO. GB2428579, issued on Jul. 2, 2007, to Pau et al. teaches a mini electric heater for an oil warmer.

It is apparent now that numerous innovations for decorative lighting systems have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a college and pro sports warmer device that avoids the disadvantages of the prior art.

ANOTHER OBJECT of the present invention is to provide a college and pro sports warmer device that is simple and inexpensive to manufacture.

STILL ANOTHER OBJECT of the present invention is to provide a college and pro sports warmer device that is simple to use.

BRIEFLY STATED, STILL YET ANOTHER OBJECT of the present invention is to provide a college and pro sports warmer device which comprises a housing having multiple sides, a bottom wall and an open top. A fragrance producing medium is disposed upon the top wall of the housing. A mechanism within the housing is for heating the fragrance producing medium to pleasantly scent vapor in a room. A sports' team text message (e.g. name) and sports team' logo are displayed simultaneously on at least one side of the housing.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a perspective view showing the present invention in use in a residential setting;

FIG. 2 is an enlarged perspective view of the present invention per se;

FIG. 3 is a cross sectional view taken along line 3-3 in FIG. 2;

FIG. 4 is an exposed view of the bottom the fragrance oil warmers;

FIG. 5A is a triangle shape of the fragrance oil warmers;

FIG. 5B is a square shape of the fragrance oil warmers;

FIG. 5C is pentagon shape of the fragrance oil warmers;

FIG. 5D is a hexagon shape of the fragrance oil warmers; and

FIG. 5E is a circular shape of the fragrance oil warmers.

### REFERENCE NUMERALS UTILIZED IN THE DRAWING

110 college and pro sports fragrance oil warmer device
112 housing of device 110
114 side of housing 112
116 bottom wall of housing 112
118 open top of housing 112
120A fragrance producing medium of device 110
120B vapor of fragrance
122 heating mechanism of device 110
124 room
126A sports team's name
126B sports team's logo of device 110
128 glass bowl of device 110
130 socket of heating mechanism 122
132 low wattage halogen bulb of heating mechanism 122
134 electric cord of heating mechanism 122
136 dimmer switch of heating mechanism 122
136A low power button
136B medium power button
136C high power button
138 protective fire resistant cylinder of device 110

### DETAILED DESCRIPTION OF THE PREFERRED EMBODIMENT

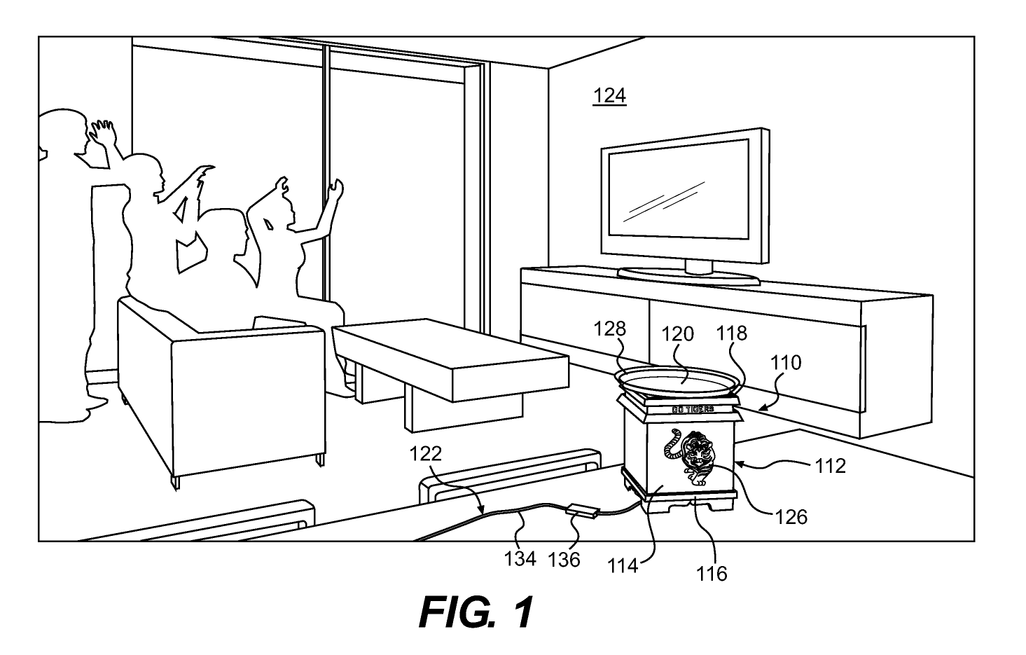

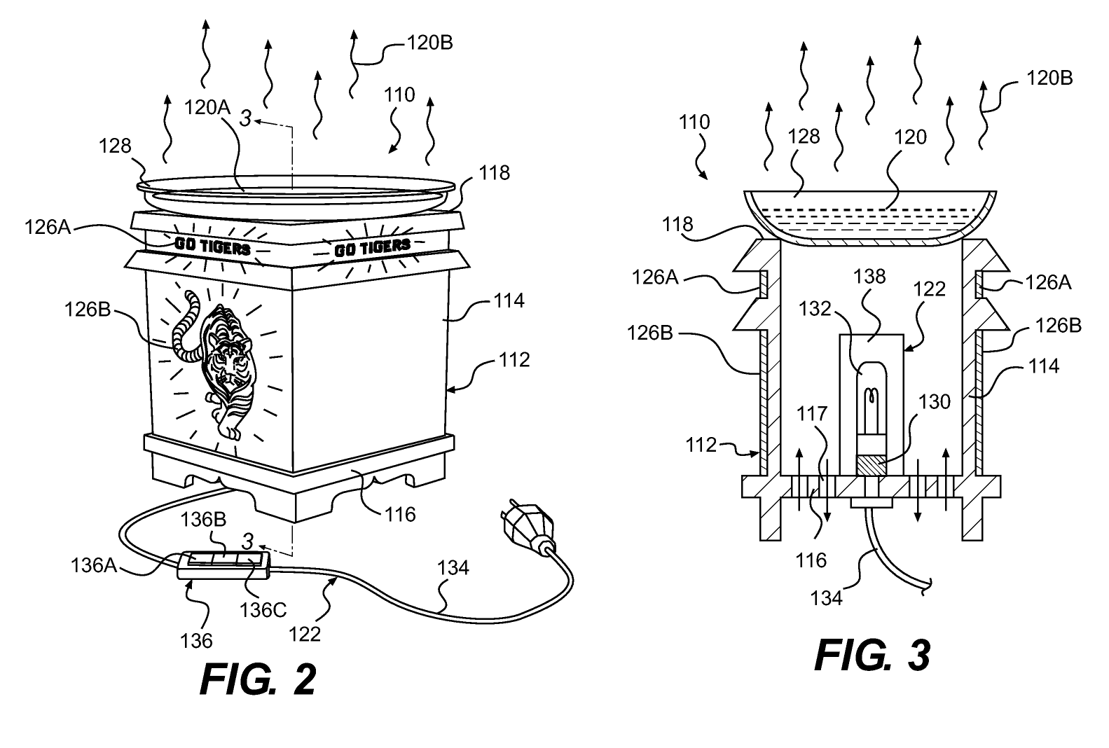

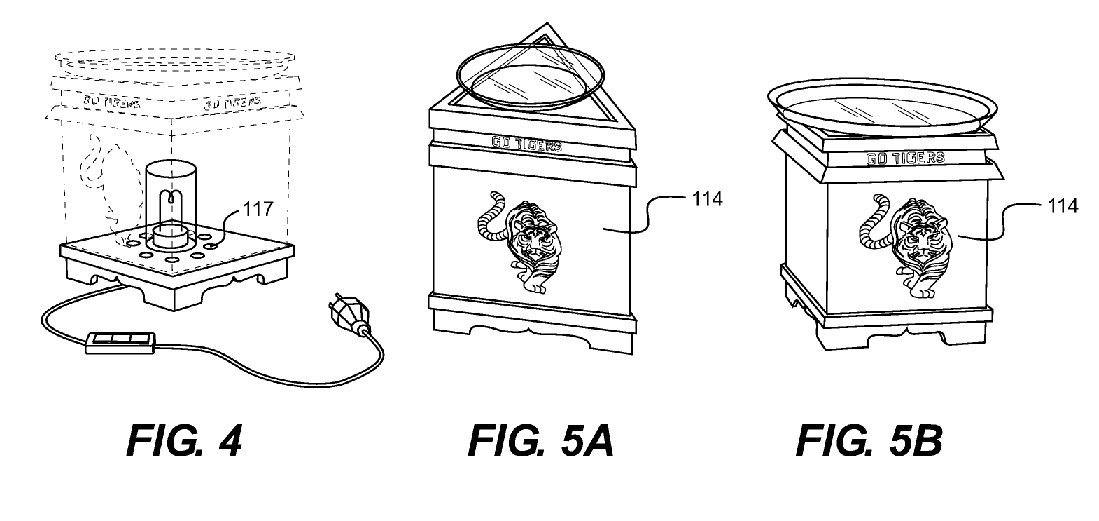

Referring now to the figures, in which like numerals indicate like parts, and particularly to FIGS. 1 through 5, and as such, will be discussed with reference thereto.

The present invention is a college and pro sports fragrance oil warmer device 110 which comprises a housing 112 having multiple sides 114, a bottom wall 116 and an open top 118. A fragrance producing medium 120 is disposed upon the open top 118 of the housing 112. For simplicity, the housing 112 can have four sides. A mechanism 122 within the housing 112 is for heating the fragrance producing medium 120 to pleasantly scent air in a room 124. At the same time, a sports' team name (or text message) 126A and a sports' team name logo 126B are displayed simultaneously upon at least one side 114 of the housing 112.

The device 110 further comprises a glass bowl 128 positioned on the open top 118 of the housing 112, wherein the glass bowl 128 holds the fragrance producing medium 120 therein. The bowl 128 has a preferred thickness of 2 mm to 1 cm. The fragrance producing medium 120A is selected from the group consisting of scented wax, potpourri, solid fragrance, liquid fragrance, oils and gels.

The heating mechanism 122 comprises a socket 130 is mounted onto the bottom wall 116 within the housing 112. A low wattage halogen bulb 132 is threaded into the socket 130. The low wattage is about 5-100 watts. An electric cord 134 extends from the socket 130 and out of the bottom wall 116 of the housing 112 to an electric wall outlet (not shown). Alternatively, the device 110 can be powered from rechargeable batteries.

A dimmer switch 136 is on the electric cord 134 to control the brightness in three levels (low, medium and high according to the buttons 136A, 136B, 136C) of the halogen bulb 132, so that a person can set a desired temperature within the housing 112 to determine the amount of fragrance vapor 120B that would permeate into the air of the room 124 from the fragrance producing medium 120.

A protective fire resistant cylinder 138 can fit over the halogen bulb 132 and the socket 130. Simultaneously, the sports' team name (or text message such as Go Tigers,..) 126A and sports' team logo 126B are selected from the group consisting of an image, a slogan, a mascot, a symbol showing loyalty to a particular favorite college or professional team. The bottom wall 116 has vents 117 or through-holes 117 for venting the heating air inside the device 110 in order to reduce overheat. The vents 117 are in a circular configuration surrounding the heating means (e.g. light bulb 132).

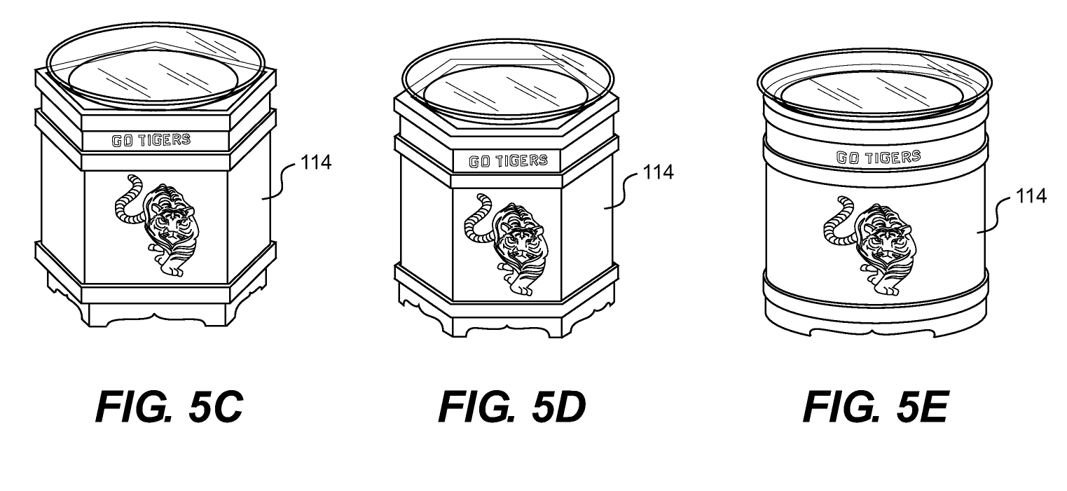

The college and pro sports fragrance oil warmer device 110 can warm scented oils to permeate the air (with vapor 120B) while also simultaneously displaying loyalty to one's favorite college or professional sports team. The housing 112 of the device 110 may be produced from semitransparent material (glass, plastic). The housing 112 may have cutout or recessed areas featuring a school or sport's team text message (e.g. name) and school or team mascot 126B and may be produced in team colors. Scented oil 120A is placed in the glass bowl 128 and sits on the open top 118 the housing 112. Inside the housing 112 the two-prong halogen light bulb 132 in the socket 130 is connected to the electric cord 134, which when plugged into the wall outlet produces heat. This heat then activates the oils causing a fragrance vapor 120B in the air. The halogen light bulb 132 and socket 130 has the protective fire resistant cylinder 138 over it. The dimmer switch 136 may have three settings (with three buttons 136A-136B) that can be adjusted to suit the persons' preferences. The settings may include, but are not limited to, low, medium and high (136A, 136B, 136C) or one button 136A for on/off and two buttons 136B-136C for low/high. This adjusts the amount of heat coming from the device 110. The dimmer switch 136 is located on the electric cord 134, which connects to the bottom of the socket 130 and comes out of the center of the bottom wall 116 of the housing 112. The device 110 may also feature a scrolling marquee around the top and may display a slogan or text message 126A that pertains to the individual team showcased on the device 110. The device 110 may measure approximately six inches high and five inches wide. The housing 112 may be produced from wood, translucent plastic or another similar material in a variety of colors. Professional and college teams featured on the housing 112 may vary. The device 110 can be customized by the buyer (e.g. buyer can purchase sticky sports' team name and logo' labels. The buyer then the labels put into the recessed areas or cut-outs). Also, the sports' team name 126A and logo 126B (on the device 110) are pre-manufactured by the manufacturers. The device 110 is plugged into a standard electrical outlet 110-120 Volts (or 220 Volts) for power. The exact dimensions, materials used for construction and method of operation of the college and pro sports fragrance oil warmer device 110 may vary upon manufacturing. The housing 112 can have three sides 114, four sides (square) 114, five sides (pentagon) 114, six sides (hexagon) 114 or circular form (as in FIGS. 5A-5E).

It will be understood that each of the elements described above, or two or more together, may also find a useful application in other types of constructions differing from the types described above.

While the invention has been illustrated and described as embodiments of a college and pro sports warmer device, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A college and pro sports fragrance oil warmer device for simultaneously producing light, fragrance, text messages and logos in a room which comprises:
a) a housing having a number of sides, a bottom wall and an open top;
b) a fragrance producing medium disposed on a bowl upon said open top of said housing;
c) means located within said housing for using light to heat said fragrance producing medium on a bowl to a pleasantly scent vapor in the room;
d) a sports' team text message is simultaneously displayed on a top at least one side of the housing; and
e) a sports' team logo is also simultaneously displayed on at least one side of said housing.

2. The device as recited in Claim 1, further comprising the bowl is made of glass.

3. The device as recited in Claim 1, further comprising the number of sides is selected from a group of 3 sides (triangle), 4 sides (square), 5 sides (pentagon), 6 sides (hexagon) and circular.

4. The device as recited in Claim 1, wherein said fragrance producing medium is selected from a group consisting of scented wax, potpourri, solid fragrance, liquid fragrance, oils and gels.

5. The device as recited in claim 1, wherein said heating means comprises:
a) a low wattage halogen bulb in socket mounted onto said bottom wall within said housing;
b) an electric cord extending from said socket and out of said bottom wall of said housing to an electric wall outlet; and
c) a dimmer switch on said electric cord to control the brightness in three levels low, medium and high of the halogen bulb of said halogen bulb, so that a person can set a desired temperature within said container to determine the amount of fragrance that would permeate into the air of the room from said fragrance producing medium.

6. The device as recited in Claim 4, further comprising a protective fire resistant cylinder which fits over said halogen bulb and said socket.

7. The device as recited in Claim 1, wherein said sports' team text message and said sports' team logo are selected from the group consisting of an image, a slogan, a mascot, a symbol showing loyalty to a particular college/professional team.

8. The device as recited in Claim 1, further comprising the vents on the bottom wall in a circular configuration surrounding the heating means.

9. The device as recited in Claim 1, wherein said heating means comprises:
a) a low wattage halogen bulb in socket mounted onto said bottom wall within said housing;
b) an electric cord extending from said socket and out of said bottom wall of said housing to an electric wall outlet; and
c) a dimmer switch on said electric cord to control the brightness in two levels low, and high of the halogen bulb of said halogen bulb, so that a person can set a desired temperature within said container to determine the amount of fragrance that would permeate into the air of the room from said fragrance producing medium.

10. The device as recited in Claim 1, wherein said heating means can be powered from rechargeable batteries.

11. The device as recited in Claim 1, wherein the sides are made of semitransparent material.

12. The device as recited in Claim 5, wherein said low wattage is about 5 watts to 100 watts.
